(19) United States
(12) Patent Application Publication
(10) Pub. No.: US 2017/0060531 A1
(43) Pub. Date: Mar. 2, 2017

(54) Devices and related methods for simplified proofreading of text entries from voice-to-text dictation

(71) Applicant: Fred E. Abbo, La Jolla, CA (US)

(72) Inventor: Fred E. Abbo, La Jolla, CA (US)

(21) Appl. No.: 15/205,720

(22) Filed: Jul. 8, 2016

Related U.S. Application Data
(60) Provisional application No. 62/210,857, filed on Aug. 27, 2015.

(51) Int. Cl. G06F 3/16; G06F 3/0488; G06F 17/24; G10L 15/26; G06F 3/0484

(52) U.S. Cl. CPC G06F 3/167; G10L 15/26; G06F 3/04842; G06F 17/24; G06F 3/0488

(57) ABSTRACT

Disclosed generally are voice-to-text dictation devices with improved software for simplified proofreading of text entries from voice-to-text dictation. One voice-to-text dictation device may suitably feature a touch-display, a microphone or other audio receiver, and computer hardware and memory. Preferably, the computer memory features software. In one embodiment, the software (in coordination with computer hardware and memory of the device) is configured to automatically and simultaneously during a speech: (1) create a voice recording file from spoken words provided to the microphone of the device; (2) convert the spoken words to an editable text document; and (3) synchronize the timing of words in the voice recording with the position of the words in the text document.

### CROSS-REFERENCE TO RELATED APPLICATIONS

This application claims the priority and benefit of Prov. App. Ser. No. 62/210,857 (filed Aug. 27, 2015) and entitled “Devices and related methods for simplified proofreading of text entries from voice-to-text dictation.”

### STATEMENT REGARDING FEDERALLY SPONSORED RESEARCH OR DEVELOPMENT

Not applicable.

### BACKGROUND OF THE INVENTION

1. Field of Invention

The subject matter described is in the field of devices and related methods for simplified proofreading of text entries from voice-to-text dictation.

2. Background of the Invention

Voice-to-text dictation devices generally feature a display, a microphone or other audio receiver coupled to computer hardware, and memory with software for translating spoken words or audio-files into text presented on the display. Typically, the software further creates a text-file containing the translated text, wherein the text-file is saved to the computer memory of the device so that it may be accessed at a later time. In recent years, smartphones have been used as dictation devices because such phones (a) feature a display, a microphone, computer hardware, and computer memory, and (b) can be readily outfitted with appropriate voice-to-text software.

In a basic embodiment, voice-to-text software uses the computer hardware of voice-to-text dictation device to compare a spoken word to a database of audio and text representations of words so that if a match occurs between the spoken word and an audio representation of a word in the database, then the text representation of the matched word is presented on the display. This basic embodiment has inherent limitations that frequently cause inaccurate text translations of the spoken word to be translated. For instance, if a spoken word does not have a match in the database, then the software either guesses a word to be presented as text or leaves the word out of the text translation. Relatedly, if a spoken word is not clearly picked-up by the microphone or receiver of the device the word could be left-out of the translation or mistranslated.

Inaccuracies of text-translation of spoken words by voice-to-text dictation devices can be problematic in many circumstances. For example, accuracy is paramount when doctors dictate notes or commentary about a patient's visit into voice-to-text dictation devices. In this situation, such text may be later referenced by the doctors for diagnosing medical conditions or prescribing medications and inaccuracies in voice-to-text translations could lead to malpractice. For this reason, software for voice-to-text dictation devices usually feature a proofreading or other editing function, whereby the translated text can be reviewed and updated for accuracy of translation.

Despite said proofreading and editing functionalities, real-time review of translated text of a voice-to-text dictation device is not always possible and post hoc review of the translated text is not satisfactory in every situation. Continuing the example above, a doctor may not have time during a busy schedule to review dictated notes during or immediately after a patient's visit and context is lost if the notes are reviewed later but found to have unintelligible text translations. In view of the foregoing, some voice-to-text dictation devices save an audio file or voice recording of the spoken words for later reference during proofreading or editing.

Saved audio files or voice recordings can also be problematic during editing or proofreading of voice-to-text translations. Specifically, finding the location of a mistranslated word in an audio file or voice recording can be time consuming or tedious because the text word, being mistranslated in the first place, cannot be heard in the audio file. Thus, a need exists for voice-to-text dictation devices that synchronize the position of words within a translated text file from spoken words with the timing of words in audio files (or voice recordings) of the spoken words.

### SUMMARY OF THE INVENTION

In view of the foregoing, it is an objective of this disclosure to describe voice-to-text dictation devices with improved software for simplified proofreading of text entries from voice-to-text dictation. Suitably, a voice-to-text dictation device is disclosed having a touch-display, a microphone or other audio receiver, and computer hardware and memory. Preferably, the computer memory features software. In one embodiment, the software (in coordination with computer hardware and memory of the device) is configured to automatically and simultaneously during a speech: (1) create a voice recording file from spoken words provided to the microphone of the device; (2) convert the spoken words to a text document; and (3) synchronize the timing of words in the voice recording with the position of the words in the text document. After recording and text recognition, the software is configured to present a proofreading or editing interface to the user via the display of the device. In a preferred embodiment, the text of the text document is presented on the touch interface of the device. Suitably, when an ambiguous or distorted word or phrase needs clarification/editing, the word or phrase may be interacted with (e.g., by tapping) via the touch interface wherein (a) arrows, e.g., “->” and “<-”, are presented below the subject word on the display and (b) the program automatically selects from the voice recording file, the corresponding dictation, and plays the voice recording for five seconds (two and a half seconds before and two and a half seconds after the subject word). In one instance, if the played voice recording segment does not include the subject word or phrase, then the arrows may be interacted with to move the voice recording forward or backward to find the appropriate voice recording segment or for more context. Suitably, the arrows, when tapped or otherwise interacted with, moves the voice recording time line and played voice recording segment, forward or backward 5 seconds. Preferably, the software enables appropriate correction so that the text document can be updated and further proofreading can continue. Suitably, when the file has been completely proofread, the software is configured to document the modifications and record the identity of the proofreader. e.g., “Proofread by XYZ on XXX date and time.”

### BRIEF DESCRIPTION OF THE FIGURES

Other objectives of the invention might become apparent to those skilled in the art once the invention has been shown and described. The manner in which these objectives and other desirable characteristics can be obtained is explained in the following description and attached figures in which:

FIG. 1 is a environmental view of a voice dictation device;

FIG. 2 is a preferred display of a voice dictation device;

FIG. 2A is an environmental view of a voice dictation device;

FIG. 2B is another environmental view of a voice dictation device;

FIG. 3 is another preferred display of a voice dictation device;

FIG. 3A is another environmental view of the voice dictation device; and,

FIG. 3B is another environmental view of the voice dictation device.

It is to be noted, however, that the appended figures illustrate only typical embodiments of this invention and are therefore not to be considered limiting of its scope, for the invention may admit to other equally effective embodiments that might be appreciated by those reasonably skilled in the relevant arts. Also, figures are not necessarily made to scale but are representative.

### DETAILED DESCRIPTION OF PREFERRED EMBODIMENTS

Disclosed generally are voice-to-text dictation devices with improved software for simplified proofreading of text entries from voice-to-text dictation. One voice-to-text dictation device 1 may suitably feature a touch-display, a microphone or other audio receiver, and computer hardware and memory. Preferably, the computer memory features software.

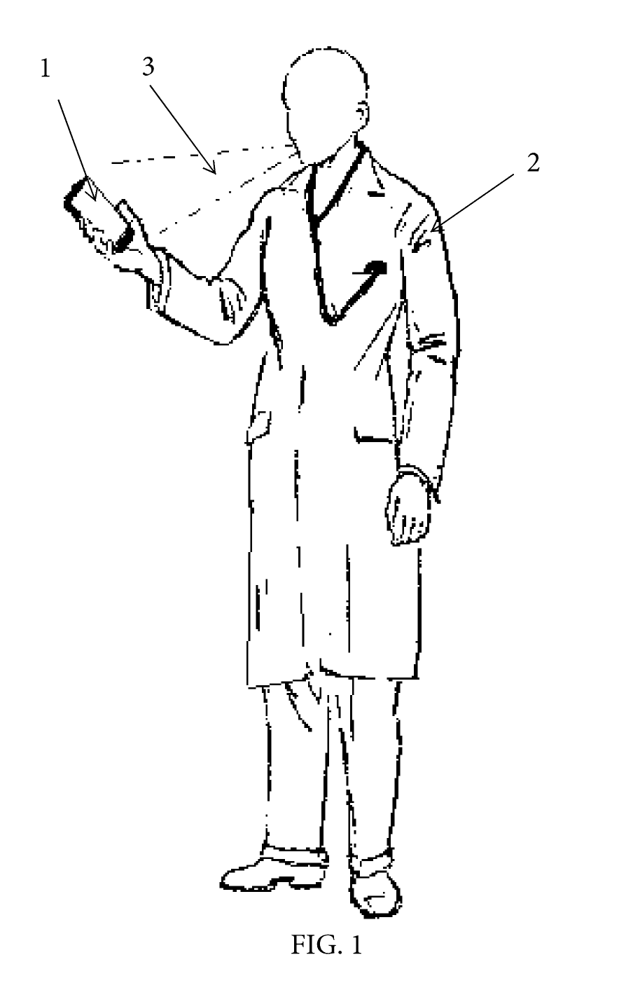

FIG. 1 is a contextual view of the voice dictation device 1 in the hand of a doctor 2 or other individual. As shown, the doctor 2 speaks or otherwise directs speech 3 toward the device 1. In one embodiment, the software (in coordination with computer hardware and memory of the device 1) is configured to automatically and simultaneously during a speech 3: (1) create a voice recording file from spoken words 3 provided to the microphone of the device 1; (2) convert the spoken words 3 to an editable text document; and (3) synchronize the timing of words in the voice recording (hereinafter “voice recording time”) with the position of the words in the text document. Software for creating voice recordings and text translations of spoken words 3 into a microphone or other receivers are well-known to those of skill in the art.

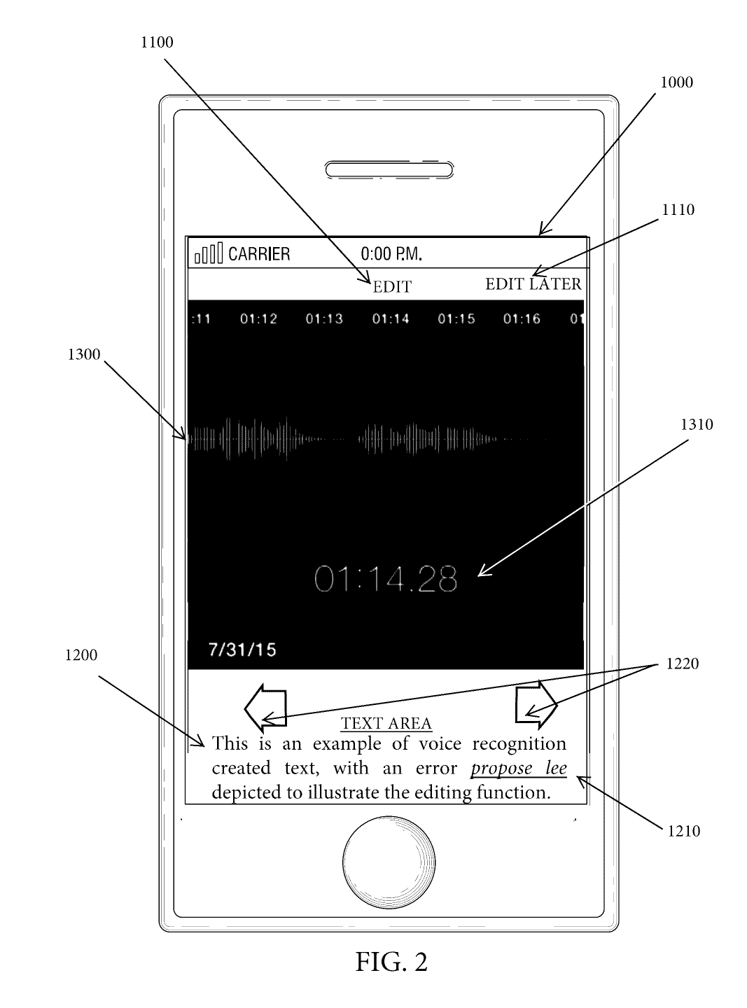

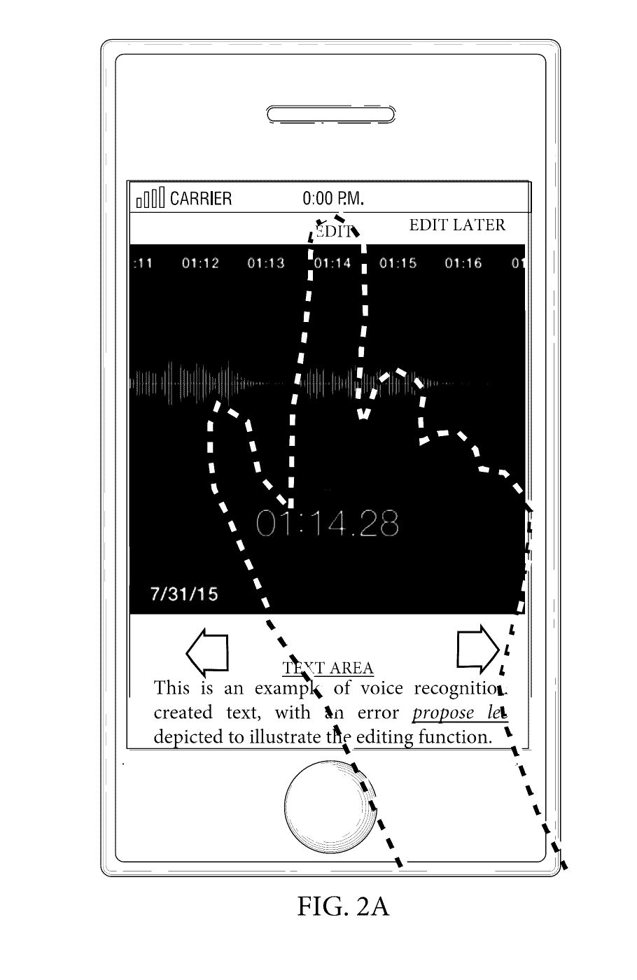

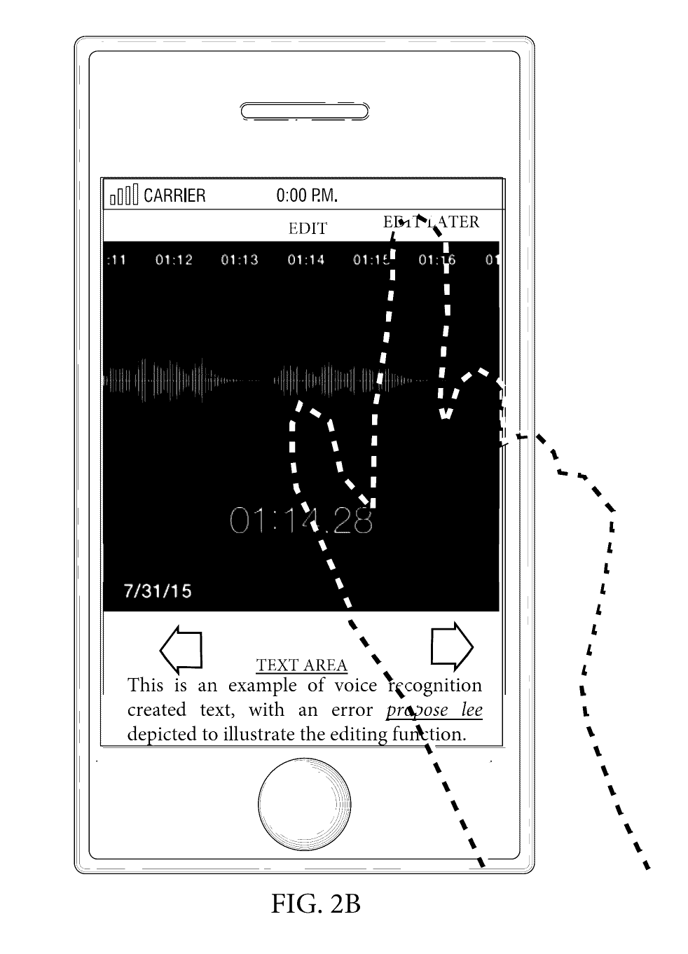

After recording and text recognition, the software is configured to present a proofreading or editing interface to the user via the display 1000 of the device 1. FIG. 2 illustrates an exemplary interface 1000 for presentation on the display of the device (not shown). In one instance, the editing or proofreading interface is triggered by interaction with an “edit now” or “edit” command button 1100 presented on the touch display 1000 by the software after creation of the editable text document 1200. See, e.g., FIG. 2A. Alternatively, the created editable text document can be saved “as is” by electing an “edit later” button 1110 presented on the touch display by the software after creation of the editable text document 1200. See, e.g., FIG. 2B.

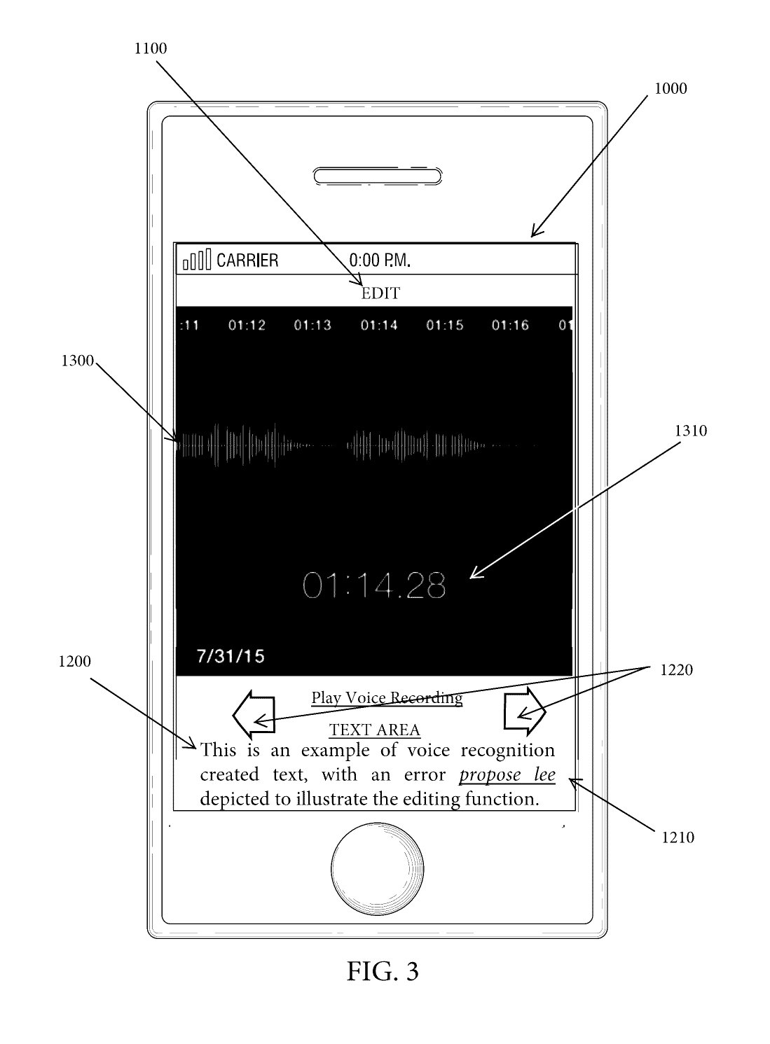

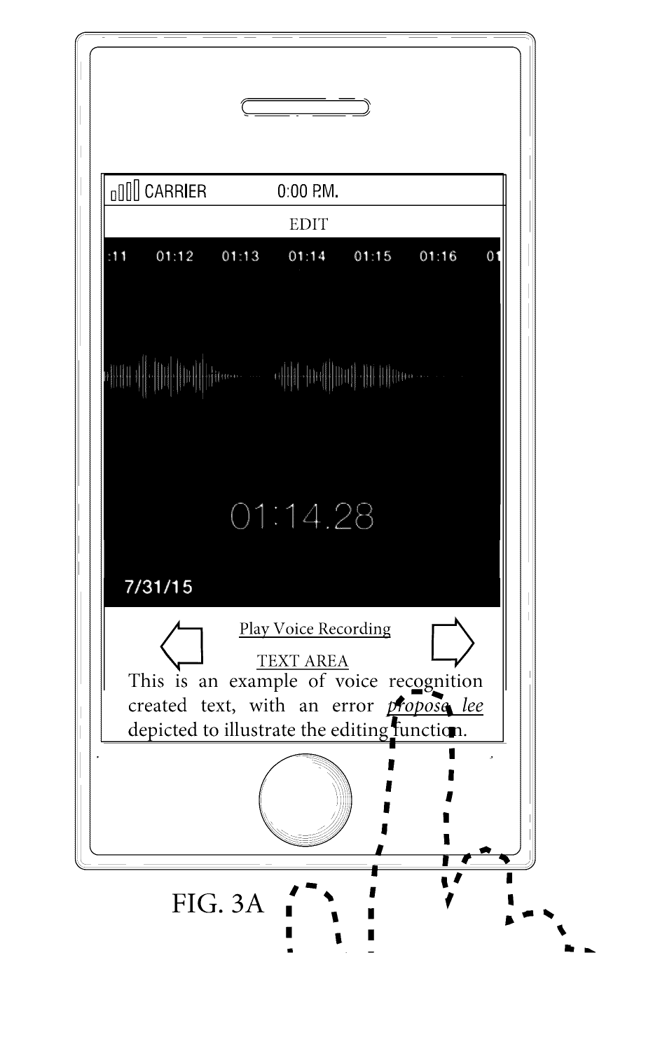

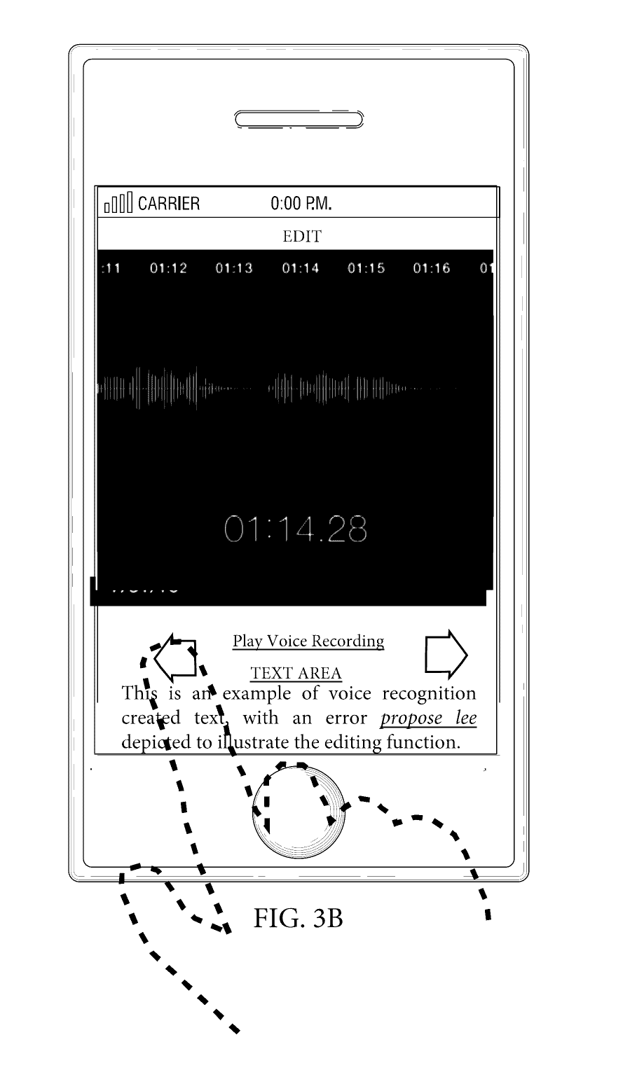

In a preferred embodiment of the editing or proofreading interface 1000 (herein after “edit mode”), the text of the editable text 1200 document is presented on the touch interface 1000 of the device. FIG. 3 illustrates a text interface on a device. Suitably, when an ambiguous or distorted word or phrase 1210 needs clarification/editing (herein after the “target text.”), the target text 1210 may be interacted with (e.g., by tapping) via the touch interface. See, e.g., FIG. 3A. As shown, the erroneous text is “propose lee” but should be “purposely.” Suitably, (a) arrows, e.g., “->” and “<-” 1220, are presented on the display 1000 before or after interaction with the target text 1210 and (b) the program automatically selects, from the voice recording file 1300, the excerpt 1310 of the file 1300 corresponding to the target text 1210 plus plays the voice recording for five seconds (two and a half seconds before and two and a half seconds after the target text). Suitably, the five second playback may be changed to four seconds by a user. In a preferred embodiment, the automatic selection of the excerpt 1310 to be played after selection of the target text 1210 is accomplished by:
(1) Determining the number of alphanumeric characters plus spaces in the beginning of the editable text 1200 to the target text 1210 (this number is hereinafter referred to as the “target text distance”);
(2) Determining the total number of alphanumeric characters plus spaces in the editable text 1200 (hereinafter “total text distance”);
(3) Calculating an “edit ratio” by dividing the target text 1210 distance by the total text distance;
(4) Calculating the “correction voice recording time point” 1310 by multiplying the edit ratio by the voice recording time; and,
(5) Playing a five second excerpt of the voice recording from the correction voice recording time point.

FIG. 3 the interface 1000 for display on a device. In one instance, if the played voice recording segment 1310 does not include the target text 1210, then the arrows 1220 may be interacted with to move the voice recording forward or backward in time to find the appropriate voice recording segment or for more context. See, e.g., FIG. 3B, which illustrates interaction with a backward arrow. Suitably, the arrows 1220, when tapped or otherwise interacted with, move the voice recording time line and played voice recording segment, forward or backward 5 seconds. Preferably, the software enables appropriate correction so that the text document 1200 can be updated and further proofreading can continue. Suitably, when the file has been completely proofread, the software is configured to document the modifications and record the identity of the proofreader. e.g., “Proofread by XYZ on XXX date and time.”

Other command buttons (not shown) may suitably enable functionality for the device (not shown). For example, “transmit to,” or “transmit entire voice recording to” may be put on the screen. In one embodiment, the “transmit to” button can be used to transfer the file to a third party for editing. Further, the “transmit entire voice recording to” button may be used to transmit the voice recording to a third party or to an electronic file (e.g., an electronic medical record). Finally, the voice recording may be stored for a specified time period or indefinitely.

Although the method and apparatus are described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

Claims, as originally worded, are hereby incorporated by reference in their entirety.

I claim:

1. A voice-to-text dictation application for proofreading of text entries from voice-to-text dictation, said application comprising:
said application configured for use on a hand held device comprising:
a touch-display; a microphone; computer hardware; and computer memory featuring software; and
wherein said application, in coordination with computer hardware and computer memory of the device is configured to:
(1) create a voice recording file from spoken words provided to the microphone of the device,
(2) convert the spoken words to an editable text document, and
(3) synchronize the timing of words in the voice recording with the position of the words in the text document so that a user may selectively touch a segment of identified text and thereby audibly recall the voice recording at a defined point.

2. A computer application for use on a hand-held device comprising:
a module to create a voice file from spoken words that are converted to text;
a module that allows a user to touch the text at a desired point on a display and play the voice file at a point which corresponds to the identified text point.

3. The application of claim 2 wherein said defined point of text recalls the audio file at a point that precedes the selected point by an increment of time.

4. The application of claim 3 wherein the increment of time that precedes the selected point is in a range of one to five seconds.

5. A voice-to-text dictation device with improved software for simplified proofreading of text entries from voice-to-text dictation, said device comprising:
a touch-display;
an audio receiver;
computer hardware;
computer memory featuring software; and
wherein said software, in coordination with computer hardware and computer memory of the device is configured to automatically and simultaneously during a speech
(1) create a voice recording file from spoken words provided to the microphone of the device,
(2) convert the spoken words to an editable text document, and
(3) synchronize the timing of words in the voice recording with the position of the words in the text document.

6. The device of claim 5 wherein the software, after recording and text recognition, is configured to present a proofreading or editing interface to the user via the touch-display of the device.

7. The device of claim 6 wherein the editing or proofreading interface is triggered by interaction with a command button presented on the touch display by the software after creation of the editable text document.

8. The device of claim 7 wherein:
the editing interface presents the text of the editable text document on the touch interface of the device so that when an ambiguous or distorted word or phrase needs editing, the target text may be interacted with via the touch interface;
wherein forward and reverse command buttons are presented on the display after interaction with the target text and the software automatically selects, from the voice recording, the excerpt of the voice recording file corresponding to the target text plus plays the voice recording for five seconds.
